(19) United States
(12) Patent Application Publication
(10) Pub. No.: US 2022/0346420 A1
(43) Pub. Date: Nov. 3, 2022

(54) MODIFIER FOR FROZEN COOKED RICE, METHOD FOR MODIFYING FROZEN COOKED RICE, METHOD FOR PRODUCING MODIFIED FROZEN COOKED RICE, AND MODIFIED FROZEN COOKED RICE

(71) Applicant: AJINOMOTO CO., INC., Tokyo (JP)

(72) Inventors: Daiki IIBATA, Kawasaki-shi (JP); Yohei FUKUCHI, Kawasaki-shi (JP); Takuto HIRAMATSU, Kawasaki-shi (JP)

(73) Assignee: AJINOMOTO CO., INC., Tokyo (JP)

(21) Appl. No.: 17/731,644

(22) Filed: Apr. 28, 2022

(30) Foreign Application Priority Data
Apr. 28, 2021 (JP) 2021-076832

(51) Int. Cl. A23L 29/10; A23L 5/10; A23L 3/375; A23B 9/10; A23B 9/14; A23L 7/196

(52) U.S. Cl. CPC A23L 29/10; A23L 5/13; A23L 3/375; A23B 9/10; A23B 9/14; A23L 7/1963; A23L 7/1965

(57) ABSTRACT

Modifiers containing an emulsifier and an oil or fat, wherein the emulsifier contains one or more members selected from the group consisting of a monoester of a fatty acid having 12 to 22 carbon atoms and glycerol, a monoester of a fatty acid having 12 to 22 carbon atoms and sorbitan, a monoester of a fatty acid having 12 to 22 carbon atoms and a oolyalycerol with an average degree of polymerization of 2 to 5, and a monoester of a saturated fatty acid having 12 to 22 carbon atoms and propylene glycol, can sufficiently improve the freezing property of cooked rice during rapid freezing so that the rice grains are frozen separately from each other.

### CROSS REFERENCES TO RELATED APPLICATIONS

This application claims priority to Japanese Patent Application No. on JP2021-076832 filed on Apr. 28, 2021, which is incorporated herein by reference in its entirety.

### BACKGROUND OF THE INVENTION

### Field of the Invention

The present invention relates to modifiers for frozen cooked rice, methods for modifying frozen cooked rice, method for producing frozen cooked rice, and modified frozen cooked rice.

### Discussion of the Background

With the increase in nuclear families and single-person households, the increase in dual-income families, and changes in dietary habits such as eating alone, as the background, frozen foods are becoming more widespread at home. In particular, the expansion of the frozen cooked rice business, including not only pilaf, takikomi rice, grilled rice ball, but also even cooked white rice, which is the staple food, is remarkable.

Along with the expansion, many efforts have been made to so improve the frozen state of frozen cooked rice and to improve its texture and state after thawing.

For example, in order to improve the freezing property of cooked rice to be frozen separately from each other, a method of treating washed rice by immersing in an aqueous solution obtained by emulsifying edible oil and fat in water with an emulsifier has been proposed (see JP-A-s59-109144, which is incorporated herein by reference in its entirety), and in order to improve the loosening, property of rice grains after thawing, oil and fat for cooked rice, containing an emulsifier composed of polyglycerol condensed ricinoleic acid ester and one or more members selected from the group consisting of glycerol monofatty acid ester, citric acid monoglyceride, diacetyl tartaric acid monoglyceride, sucrose fatty acid ester, and polyglycerol fatty acid ester containing oleic acid as the main constituent fatty acid has been proposed (see JP-A-h3-175940, which is incorporated herein by reference in its entirety).

In addition, in order to prevent the cooked rice grains from adhering to each other and to afford a texture of separated rice, a method of treating cooked rice with an aqueous solution containing an emulsifier having an affinity for water, such as sucrose fatty acid ester, and salts has been proposed (see JP-A-2000-217522, which is incorporated herein by reference in its entirety).

Furthermore, as a technique for improving the taste and texture of frozen cooked rice after thawing, a technique including covering the surface of cooked rice with a water-in-oil emulsion composition containing a flavored aqueous phase in the oil phase, and then freezing the cooked rice rapidly so that the rice grains are separately frozen has been proposed (see JP-A-h9-224625, which is incorporated herein by reference in its entirety), and a frozen cooked rice-improving agent containing edible oil or fat, propylene glycol fatty acid ester, and triglycerolfatty acid ester and/or tetraglycerolfatty acid ester has been proposed (see JP-A-2009-082025, which is incorporated herein by reference in its entirety).

However, frozen cooked rice in which the rice grains are separately frozen rapidly by the techniques reported so far still has room for improvement in the separately freezing property, and it cannot he said that frozen cooked rice with sufficiently satisfactory property of freezing separately has been obtained.

### SUMMARY OF THE INVENTION

Accordingly, it is one object of the present invention to s provide a modifier for frozen cooked rice that can sufficiently improve the freezing property of cooked rice during rapid freezing so that the rice grains are frozen separately from each other.

It is another object of the present invention to provide frozen cooked rice with sufficiently improved separately freezing property of rice grains.

It is another object of the present invention to provide a production method thereof.

These and other objects, which will become apparent during the following detailed description, have been achieved by the present inventors' discovery that a composition containing an emulsifier and an oil or fat, in which the emulsifier contains one or more members selected from the group consisting of a monoester of a fatty acid having 12 to 22 carbon atoms and glycerol, a monoester of a fatty acid having 12 to 22 carbon atoms and sorbitan, a monoester of a fatty acid having 12 to 22 carbon atoms and a polyglycerol with an average degree of polymerization of 2 to 5, and a monoester of a saturated fatty acid having 12 to 22 carbon atoms and propylene glycol, can favorably improve the freezing property of cooked rice during rapid freezing so that the rice grains are frozen separately from each other, which resulted in the completion of the present invention.

In addition, they have found that a composition containing an emulsifier and an oil or fat, in which the emulsifier contains one or more members selected from the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of , fatty acid having 14 to 22 carbon atoms and a polyglycerol with an average degree of polymerization of 2 to 5, can favorably improve the above-mentioned freezing property, as well as the taste and texture of frozen cooked rice after thawing by a microwave cooker, and provided this as a preferred embodiment of the present invention.

That is, the present invention provides the following.
(1) A modifier for frozen cooked rice, comprising an emulsifier and an oil or fat, wherein the emulsifier comprises one or more members selected from the group consisting of a monoester of a fatty acid having 12 to 22 carbon atoms and glycerol, a monoester of a fatty acid having 12 to 22 carbon atoms and sorbitan, a monoester of a fatty acid having 12 to 22 carbon atoms and a polyglycerol with an average degree of polymerization of 2 to 5, and a monoester of a saturated fatty acid having 12 to 22 carbon atoms and propylene glycol.
(2) The modifier of (1), wherein the emulsifier comprises one or more members selected from the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of a fatty acid having 14 to 22 carbon atoms and a polyglycerol with an average degree of polymerization of 2 to 5.
(3) The modifier of (1) or (2), wherein the emulsifier has an HLB (Hydrophilic-Lipophilic Balance) value of 3.8 to 6.5.
(4) The modifier of any one of (1) to (3) , wherein a content of the emulsifier is 0.6 wt % to 80 wt % based on the total amount of the modifier.
(5) The modifier of any one of (1) to (4), wherein an addition amount of the emulsifier is 0.01 g to 7 g per 100 g of the rice.
(6) The modifier of any one of (2) to (5) , wherein the modifier is for frozen cooked rice that is thawed by a microwave cooker.
(7) The modifier of any one of (1) to (6), wherein the modifier for frozen cooked white rice.
(8) A method for modifying frozen cooked rice, comprising bringing uncooked rice grains used for producing frozen cooked rice into contact with a modifier for frozen cooked rice which comprises an emulsifier and an oil or fat, wherein the emulsifier comprises one or more members selected from the group consisting of a monoester of a fatty acid having 12 to 22 carbon atoms and glycerol, a monoester of a fatty acid having 12 to 22 carbon atoms and sorbitan, a monoester of a fatty acid having 12 to 22 carbon atoms and a polyglycerol with an average degree of polymerization of 2 to 5, and a monoester or a saturated fatty acid having 12 to 22 carbon atoms and propylene glycol.
(9) The method of (8), wherein the emulsifier comprises one or more members selected from the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of a fatty acid having 14 to 22 carbon atoms and a polyglycerol with an average degree of polymerization of 2 to 5.
(10) The method of (8) or (9), wherein the emulsifier has an FILE (Hydrophilic-Lipophilic Balance) value of 3.8 to 6.5.
(11) The method of any one of (8) to (10), wherein a content of the emulsifier is 0.6 wt % to 80 wt % based on the total amount of the modifier.
(12) The method of any one of (8) to (11), wherein an amount of the emulsifier is 0.01 g to 7 g per 100 g of the rice.
(13) The method of any one of (9) to (12), wherein the frozen cooked rice is to be thawed by a microwave cooker.
(14) The method of any one of (8) to (13), wherein the frozen. cooked rice is frozen cooked white rice.
(15) A method for producing frozen cooked rice, comprising a step of adding water, an emulsifier, and an oil or fat to uncooked rice and cooking the rice, or adding water to uncooked rice, cooking the rice, and adding an emulsifier and an oil or fat to the cooked rice, and a step of rapidly freezing the cooked rice to give rice grains frozen separately from each other, wherein the emulsifier comprises one or more members selected from the group consisting of a monoester of a fatty acid having 12 to 22 carbon atoms and glycerol, a monoester of a fatty acid having 12 to 22 carbon atoms and sorbitan, a monoester of a fatty acid having 12 to 22 carbon atoms and a polyglycerol with an average degree of polymerization of 2 to 5, and a monoester of a saturated fatty acid having 12 to 22 carbon atoms and propylene glycol.
(16) The method of (15), wherein the emulsifier comprises one or more members selected from. the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of a fatty acid having 14 to 22 carbon atoms and a polyglycerol with an average degree of polymerization of 2 to 5.
(17) The method of (15) or (16), wherein the emulsifier has an HLB (Hydrophilic-Lipophilic Balance) value of 3.8 to 6.5.
(18) The method of any one of (15) to (17), wherein a content of the emulsifier is 0.6 wt % to 80 wt % based on the total amount of the oil or fat and the emulsifier.
(19) The method of any one of (15) to (18), wherein an amount of the emulsifier is 0.01 q to 7 g per 100 g of the rice.
(20) The method of any one of (16) to (19), wherein the frozen so cooked rice is to be thawed. by a microwave cooker.
(21) The method of any one of (15) to (20) , wherein the frozen cooked rice is frozen cooked white rice.
(22) A modified frozen cooked rice comprising the modifier of any one of (1) to (5).
(23) A modified frozen cooked rice comprising the modifier of any one of (2) to (5) and to be thawed by a microwave cooker. (24) The frozen cooked rice of (22) or (23), wherein the frozen cooked rice is frozen cooked. white rice.

### Effect of the invention

According to the present invention, a modifier for frozen cooked rice is provided that can favorably improve the freezing property of cooked rice during rapid freezing so that the rice grains are frozen separately from each other.

According to the present invention, a method for modifying frozen cooked rice is provided that can improve the freezing property or cooked rice during rapid freezing so that the rice grains are frozen separately from each other.

According to the present invention, moreover, a method for producing frozen cooked rice is provided, which frozen cooked rice is improved in the freezing property of cooked rice during rapid freezing so that the rice grains are frozen separately from each other and become loose with ease.

According to the present invention, furthermore, frozen cooked rice is provided that is improved in the freezing property of cooked rice during rapid freezing so that the rice grains are frozen separately from each other, and modified to become loose with ease after freezing.

In a preferred embodiment of the present invention, a modifier for frozen cooked rice is provided that can improve, in addition to the freezing property of cooked rice during rapid freezing so that the rice grains are frozen separately from each other, the texture and state of cooked rice obtained by thawing frozen cooked rice by a microwave cooker.

In a preferred embodiment of the present invention, a method for modifying frozen cooked rice is provided that can improve, in addition to the freezing property of cooked rice during rapid freezing so that the rice grains are frozen separately from each other, the texture and state of cooked rice obtained by thawing frozen cooked rice by a microwave cooker.

In a preferred embodiment of the present invention, moreover, a method for producing frozen cooked rice is provided, which frozen cooked rice is improved in, in addition to the freezing property of cooked rice during rapid freezing so that the rice grains are frozen separately from each other, the texture and state of cooked rice obtained by thawing frozen cooked rice by a microwave cooker.

In a preferred embodiment of the present invention, furthermore, frozen cooked rice is provided that shows, in addition to the freezing property of cooked rice during rapid freezing so that the rice grains are frozen separately from each other, good texture and good state of cooked rice after thawing by a microwave cooker, and is suitable for thawing by a microwave cooker.

### DETAILED DESCRIPTION OF THE PREFERRED EMBODIMENTS

The present invention provides a modifier for frozen cooked rice (hereinafter also to be referred to as “the modifier of the present invention” in the present specification”).

In the present specification, the “modifier for frozen cooked rice” refers to an additive used in the production step of frozen cooked rice for the purpose of improving the freezing 25 property of cooked rice during rapid freezing so that the rice grains are frozen separately from each other, or improving, in addition to the aforementioned freezing property, the texture and state of cooked rice obtained by thawing frozen cooked rice.

In the present invention, the “frozen cooked rice” refers to cooked rice that has been frozen by the below-mentioned rapid freezing so that the rice grains are frozen separately from each other, and the “cooked rice” includes cooked rice obtained by cooking polished white rice, as well as cooked brown rice, steamed rice with red beans, steamed glutinous rice, takikomi rice, pilaf, fried rice, curry pilaf, sushi rice, and the like.

The modifier of the present invention contains an oil or fat and an emulsifier, and contains one or more members selected from the group consisting of a monoester of a fatty acid having 12 to 22 carbon atoms and glycerol, a monoester of a fatty acid having 12 to 22 carbon atoms and sorbitan, a monoester of a fatty acid having 12 to 22 carbon atoms and a polyglycerol with an average degree of polymerization of 2 to 5, and a monoester of a saturated fatty acid having 12 to 22 carbon atoms and propylene glycol, as the emulsifier.

In the above-mentioned emulsifier contained. in the modifier of the present invention, the fatty acid having 12 to 22 carbon atoms that forms a monoester with glycerol, sorbitan or a polyglycerol with an average degree of polymerization of 2 Ls to 5 may by a saturated fatty acid or an unsaturated fatty acid, or a linear fatty acid, or a fatty acid having a branched chain.

In the above-mentioned emulsifier contained in the modifier of the present invention, the saturated fatty acid having 12 to 22 carbon atoms that forms a monoester with propylene glycol may be a linear fatty acid or a fatty acid having a branched chain.

The monoester of a fatty acid having 12 to 22 carbon atoms and glycerol that is contained in the modifier of the present invention is not particularly limited as long as it is edible. Specific examples thereof include glyceryl monolaurate, glyceryl monomyristate, glyceryl monopalmitate, glyceryl monopalmitoleate, glyceryl monostearate, glyceryl monoisostearate, glyceryl mondoleate, glyceryl monolinoleate, glyceryl monolinolenate, glyceryl monoarachidate, glyceryl monoarachidonate, glyceryl monobehenate, and the like.

The monoester of a fatty acid having 12 to 22 carbon atoms and sorbitan that is contained in the modifier of the present invention is not particularly limited as long as it is edible. Specific examples thereof include sorbitan monolaurate, sorbitan. monomyristate, sorbitan monopalmitate, sorbitan monopalmitoleate, sorbitan monostearate, sorbitan monoisostearate, sorbitan monooleate, sorbitan monolinoleate, sorbitan monolinolenate, sorbitan monoarachidate, sorbitan monoarachidonate, sorbitan monobehenate, and the like.

The monoester of a fatty acid having 12 to 22 carbon atoms and a polyglycerol with an average degree of polymerization. of 2 to 5 that is contained in the modifier of the present invention is not particularly limited as long as it is edible. Specific examples thereof include diglyceryl lo monofatty acid esters such as diglyceryl monolaurate, diglyceryl monomyristate, diglyceryl monopalmitate, diglyceryl monopalmitoleate, diglyceryl monostearate, diglyceryl monoisostearate, diglyceryl monooleate, diglyceryl monolinoleate, diglyceryl monolinolenate, diglyceryl monoarachidate, diglyceryl. monoarachidonate, diglyceryl monobehenate and the like; triglyceryl monofatty acid esters such as triglyceryl monolaurate, triglyceryl monomyristate, triglyceryl monopalmitate, triglyceryl monopalmitoleate, triglyceryl monostearate, triglyceryl monoisostearate, triglyceryl monooleate, triglyceryl monolinoleate, triglyceryi monolinolenate, triglyceryl monoarachldate, triglyceryl monoarachidonate, triglyceryl monobehenate and the like; tetraglyceryl monofatty acid esters such as tetraglyceryl monolaurate, tetraglyceryl monomyristate, tetraglyceryl monopalmitate, tetraglyceryl monopulmitoleate, tetraglyceryl monostearate, tetraglyceryl mondisostearate, tetraglyceryl monooleate, tetraglyceryl monolinoleate, tetraglyceryl monolinolenate, tetraglyceryl monoarachidate, tetraglyceryl monoarachidonate, tetraglyceryi monobehenate and the like; and pentaglyceryl monofatty acid esters such as pentaglyceryl monolaurate, pentaglyceryl monomyristate, pentaglyceryl monopalmitate, pentaglyceryl monopalmitoleate, pentaglyceryl monostearate, pentaglyceryl monoisostearate, pentaglyceryl monooleate, pentaglyceryl monolinoleate, pentaglyceryl monolinolenate, pentaglyceryl monoarachidate, pentaglyceryl monoarachidonate, pentaglyceryl monobehenate and the like.

From the aspect of the below-mentioned HLB value of the emulsifier, a monoester of a fatty acid having 12 to 22 carbon atoms and diglycerol (average degree of polymerization =2) is more preferably used.

The monoester of a fatty acid having 12 to 22 carbon atoms and propylene glycol that is contained in the modifier of the present invention is not particularly limited as long as it is edible. Specific examples thereof include propylene glycol monolauric acid ester, propylene glycol mono myristic acid ester, propylene glycol mono paimitic acid ester, propylene glycol monostearic acid ester, propylene glycol monoisosteari.c acid ester, propylene glycol monoarachidic acid ester, propylene glycol monobehenic acid ester, and the like.

One kind of the above-mentioned emulsifiers may be selected and used alone, or two or more kinds thereof may be selected and used in combination.

In the present invention, the above-mentioned emulsifier may be produced by a production method known per se, or commercially available products provided by each company can also be used.

The monoester of a fatty acid having 12 to 22 carbon atoms and glycerol, the monoester of a fatty acid having 12 to 22 carbon atoms and sorbitan, the monoester of a fatty acid having 12 to 22 carbon atoms and a polyglycerol with an average degree of polymerization of 2 to 5, and the monoester of a saturated fatty acid having 12 to 22 carbon atoms and propylene glycol may contain an ester having a high esterification degree, such as a diaster, in addition to the monoester as long as the characteristics of the present invention are not impaired.

From the aspect of the effect of improving the freezing property of cooked rice during rapid freezing so that the rice grains are frozen separately from each other, an emulsifier with an HLB (Hydrophilic-Lipophilic Balance) value of 3.8 to 6.5, more preferably 3.9 to 6.5, is preferred as the one or more emulsifiers selected from the group consisting of a monoester of a fatty acid having 12 to 22 carbon atoms and glycerol, a monoester of a fatty acid having 12 to 22 carbon atoms and sorbitan, a monoester of a fatty acid having 12 to 22 carbon atoms and a polyglycerol with an average degree of polymerization of 2 to 5, and a monoester of a saturated fatty acid having 12 to 22 carbon atoms and propylene glycol.

In a preferred embodiment of the present invention, one or more members selected from the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of L fatty acid having 14 to 2 carbon atoms and a polyglycerol with an average degree of polymerization of 2 to 5 is/are used as the emulsifier contained in the modifier of the present invention.

The modifier of the preferred embodiment of the present invention containing the above-mentioned emulsifier is superior in, ire addition to the effect of improving the freezing property of cooked rice during rapid freezing so that the rice grains are frozen separately from each other, the effect of improving the texture of cooked rice obtained by thawing frozen cooked rice by a microwave cooker, for example, stickiness during eating and the state of rice such as viscosity.

The oil or fat contained together with the above-mentioned emulsifier ire the modifier of the present invention is not particularly limited as long as it is an edible oil or fat capable of solubilizing or uniformly dispersing or blending the above-mentioned emulsifier, Examples thereof include plant-derived oils and fats such as avocado oil, flaxseed oil, almond oil, apricot oil, perilla oil, olive oil, cacao butter, cassis oil, cashew oil, canola oil, walnut oil, sesame oil, wheat oil, rice oil, Japanese basil oil, soybean oil, evening as primrose oil, camellia oil, corn oil, rape seed oil, palm. oil, palm kernel oil, sunflower oil, grapes seed oil, hazelnut oil, safflower oil, macadamia oil, cottonseed oil, coconut oil, peanuts oil and the like; animal-derived oils and fats such as beef tallow, whale oil, shark oil, lard and the like; purified processed oil or fat made from the aforementioned plant-derived oil or fat or animal-derived oil or fat as a starting material; and the like.

From the aspect of the oxidation stability of oil or fat, an. oil or fat having a polyunsaturated fatty acid content of not more than 30 wt % relative to the content of fatty acids constituting oil or fat is preferred. Examples of such oil or fat include canola oil, high oleic canola oil, high oleic safflower oil, high oleic sunflower oil, palm oil, palm olein (liquid. oil obtained by fractionation of palm oil), palm kernel oil, olive oil, coconut oil, lard, beef tallow and the like,

From the aspect of the handling property of oil or fat, liquid oils such as rape seed oil, canola oil, high oleic canola oil, soybean oil, corn oil, safflower oil, high oleic safflower oil, high linoleic safflower oil, sunflower oil, high oleic sunflower oil, high linoleic sunflower oil, cottonseed oil, sesame oil, rice oil, palm olein, olive oil, peanuts oil, coconut oil, and the like are preferably used.

Particularly, when the modifier of the present invention is used for modifying frozen cooked white rice, a liquid oil having a polyunsaturated fatty acid content of not more than 30 wt % relative to the content of fatty acids constituting oil or fat, for example, canola oil, high oleic canola oil, high oleic safflower oil, high oleic sunflower oil, palm olein, olive oil or the like, is used more preferably.

In the present invention, one kind of the above-mentioned oil or fat may be used alone, or two or more kinds may be selected and used as a mixture.

As the above-mentioned oil or fat, commercially available products provided by each company can also be used.

The content of the above-mentioned emulsifier in the modifier of the present invention is preferably 0.6 wt % to 80 wt %, more preferably 0.6 wt % to 32 wt %, further preferably 0.8 wt % to 6 wt %.

The modifier of the present invention can be provided in the form of a liquid, an oily gel, a paste, or the like by mixing the above-mentioned oil or fat and one or more emulsifiers selected from the group consisting of a monoester of a fatty acid having 12 to 22 carbon atoms and glycerol, a monoester of a fatty acid having 12 to 22 carbon atoms and lo sorbitan, a monoester of a fatty acid having 12 to 22 carbon atoms and a polyglycerol with an average degree of polymerization of 2 to 5, and a monoester of a saturated fatty acid having 12 to 22 carbon atoms and propylene glycol, or one or more emulsifiers selected from the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of a fatty acid having 14 to 22 carbon atoms and a polyglycerol with an average degree of polymerization of 2 to 5, dissolving or dispersing or kneading the mixture, or further dissolving or dispersing or kneading the mixture in an oily base or oily solvent.

The modifier of the present invention can contain, as necessary, food additives such as antioxidants (dl-α-tocopherol, tocopheryi acetate, etc.) and the like.

In the modifier of the present invention, one or more emulsifiers selected from the group consisting of a monoester of a fatty acid having 12 to 22 carbon atoms and glycerol, a monoester of a fatty acid having 12 to 22 carbon atoms and sorbitan, a monoester of a fatty acid having 12 to 22 carbon atoms and a polyglycerol with an average degree of polymerization of 2 to 5, and a monoester of a saturated fatty acid having 12 to 22 carbon atoms and propylene glycol, or one or more emulsifiers selected from the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of a fatty acid having 14 to 22 carbon atoms and a polyglycerol with an average degree of polymerization of 2 to 5, is used in an amount of preferably 0.01 g to 7 g, more preferably 0.01 g to 2 g, further preferably 0.015 g to 1 g, per 100 g of rice (uncooked rice, i.e., rice without a heat treatment such as boiling, roasting, and the like) in the production of frozen cooked rice.

Using the modifier of the present invention in the production of frozen cooked rice, the freezing property of cooked rice during rapid freezing so that the rice grains are frozen separately from each other can be improved.

In addition, using the modifier of the above-mentioned preferred embodiment. of the present invention in the production of frozen cooked rice, the texture and state of cooked rice obtained by thawing frozen cooked rice by a microwave cooker can be improved, in addition to the freezing property of cooked rice during rapid freezing so that the rice grains are frozen separately from each other.

The modifier of the present invention is particularly useful for the modification of frozen cooked white rice. The present invention also provides a method for modifying frozen cooked rice (hereinafter also to be referred to as the “modifying method of the present invention” in the present specification).

The modifying method of the present invention includes contacting the modifier of the present invention with rice in the production of frozen cooked rice.

The “frozen cooked rice” and “the modifier of the present invention” are as mentioned above regarding the modifier for frozen cooked rice of the present invention.

The “rice” with which the modifier of the present invention is contacted is not particularly limited as long as it is the rice used for the production of the frozen cooked rice mentioned above with respect to the modifier for frozen cooked rice of the present invention, and any rice of Japondca, Indica, and javanica can he used, and both the nonglutinous rice and the glutinous rice can be used. In addition, any of the polished white rice, the brown rice, and the partially polished brown rice can be used. In the present invention, an appropriate one according to the kind of the frozen cooked rice to be produced can be selected for use.

The method of contacting the modifier of the present invention with rice includes a method including adding the modifier of the present invention to uncooked rice or washed rice soaked in water, uniformly dispersing the modifier, and allowing the rice to stand for a while or cooking the rice, a method of adding the modifier of the present invention to uncooked rice or washed rice, and mixing them, a method of immersing uncooked rice or washed rice in a dispersion in which the modifier of the present invention is dispersed, a method of placing uncooked rice or washed rice in a dispersion in which the modifier of the present invention is dispersed and cooking the rice, a method of spraying the liquid modifier of the present invention on uncooked rice or washed rice, or a method of dispersing the modifier of the present invention in water or dissolving or dispersing the modifier in an oily base or oily solvent, and spraying same on uncooked rice or washed rice, and the like. An appropriate method can be adopted depending on the kind of rice to be brought into contact with the modifier of the present invention and the kind of frozen cooked rice to be the target of the modifying method of the present invention.

The above-mentioned immersion can he performed under conditions (immersion temperature, time, etc.) generally used for cooking rice, and rice can be cooked using general conditions and method.

In the modifying method of the present invention, the modifier of the present invention is preferably contacted. such that the above-mentioned emulsifier in the modifier of the present invention is added in an amount of 0.01 g to 7 g, more preferably 0.01 g to 2 g, further preferably 0.015 g to 1 g, per 100 g of rice.

In the modifying method of the present invention, the amount of the modifier of the present invention to be used per 100 g of rice is appropriately determined based on the kind and content of the emulsifier contained in the modifier of the present invention, and it is preferably about 0.1 g to 10 g, more preferably about 0.15 g to 5 g.

The modifying method of the present invention can improve the freezing property of cooked rice during rapid freezing so that the rice grains are frozen separately from each other, In the modifying method of the present invention, the texture and state of cooked rice obtained by thawing frozen cooked rice by a microwave cooker can be improved, in addition to the freezing property of cooked rice during rapid freezing so that the rice grains are frozen separately from each other, by contacting the modifier of the above-mentioned preferred embodiment of the present invention with rice.

The modifying method of the present invention is particularly preferably applied to the modification of frozen cooked white rice.

The present invention further provides a production method of modified frozen cooked rice (hereinafter also to be referred to as “the production method of the present invention” in the present specification).

The production method of the present invention includes a so step of adding water, an emulsifier, and an oil or fat to uncooked rice grains and cooking the rice, or adding water to uncooked rice grains, cooking the rice, and adding an emulsifier and an oil or fat to the cooked rice, and a step of rapidly freezing the cooked rice to give rice grains frozen separately from each other. In addition, a pre-stirring and frying step may be provided before the above-mentioned rice cooking step.

In the production method of the present invention, the “rice” is as mentioned above with regard to the modifying method of the present invention, and the emulsifier and an oil or fat are as mentioned above with regard to the modifier of the present invention.

The embodiment of “adding water, an emulsifier and an oil or fat to uncooked rice grains and cooking the rice” includes embodiments of adding an emulsifier and an oil or fat to uncooked rice or washed rice immersed in water, uniformly dispersing them, leaving them for a while and then cooking the rice, adding an emulsifier and an oil or fat to uncooked rice or washed rice, mixing them, adding water, and cooking the rice, immersing uncooked rice or washed rice in a dispersion of an emulsifier and an oil or fat, and cooking the rice, placing uncooked rice or washed rice in a dispersion of an emulsifier and an oil or fat, and cooking the rice, spraying a dispersion of an emulsifier and an oil or fat, and cooking the rice, and the like. An appropriate embodiment can be selected and adopted according to the kind of rice and the kind of frozen cooked rice to be produced. The emulsifier and the oil or fat may also be prepared as the above-mentioned modifier of the present invention and added to rice.

The embodiment of “adding an emulsifier and an oil or fat to cooked rice” includes embodiments of spraying a dispersion of an emulsifier and an oil or fat in water to cooked rice, or dissolving or dispersing an emulsifier and an oil or fat in an oily base or an oily solvent and spraying same on the cooked rice, and the like. The emulsifier and the oil or fat may be prepared as the liquid modifier of the present invention and sprayed, or may be prepared as the modifier of the present invention, dispersed in water as mentioned above, and sprayed.

In the production method of the present invention, the content of the emulsifier with respect to the total amount of the emulsifier and the oil or fat to be added to uncooked rice or cooked rice is preferably 0.6 wt % to 80 wt %, more preferably 0.6 wt % to 32 wt %, further preferably 0.8 wt % to 6 wt %.

In the production method of the present invention, the emulsifier is preferably added in an amount of 0.01 g to 7 g, more preferably 0.01 g to 2 g, further preferably 0.015 g to 1 with respect to 100 g of rice.

In the production method of the present invention, the oil or fat is preferably added in an amount of 0.02 g to 9.9 g, more preferably 0.5 g to 8 g, further preferably 1 g to 0 g, with respect to 100 g of rice.

When the emulsifier and oil or fat are prepared. as the modifier of the present invention and added, the amount of the modifier of the present invention to be used is appropriately determined based on the kind and content of the emulsifier contained in the modifier of the present invention. The modifier is preferably added in an amount- of about 0.1 g to 10 g, more preferably about 0.15 g to 5 g, with respect to 100 g of rice.

In the production method of the present invention, the “rice cooking” can be performed by a general method using a rice cooker or rice cooking system that is widely used in the food field.

The rice cooker and the rice cooking system that may be used are not particularly limited, and include electric rice cooker, gas rice cooker, electromagnetically heating rice cooker, steam rice cooker, pressure rice cooker, automatic rice washer and cooker, batch type or continuous type rice cookers of these, gas full automatic rice cooking system, continuous steam rice cooking system and the like. They can be appropriately selected and used according to the kind and amount of the rice to be cooked, the kind of the cooked rice to be produced, and the like.

In the production method of the present invention, the step of rapidly freezing the cooked rice into separate rice grains can also be performed as appropriate using a freezer generally employed for rapidly freezing cooked rice into separate rice grains in the field of food, such as air blast freezer, liquefied gas freezer, and contact freezer, and according to the kind, amount, and the like of the cooked rice to be frozen.

Furthermore, the production method of the present invention may include filling and packaging steps generally employed in the production of frozen cooked rice such as is filling frozen cooked rice in plastic trays and pouch bags, packaging frozen cooked rice with a plastic film, and the like.

The production method of the present invention provides frozen cooked rice that is improved in the freezing property of cooked rice during rapid freezing so that the rice grains are frozen separately from each other, and becomes loose with ease after freezing.

In the production method of the present invention, frozen cooked rice in which the texture and state of cooked rice obtained by thawing the frozen cooked rice by a microwave cooker is improved in addition to the freezing property of cooked rice during rapid freezing so that the rice grains are frozen separately from each other can be provided by using the emulsifier contained in the modifier of the above-mentioned preferred embodiment of the present invention.

The production method of the present invention can be particularly preferably used in the production of modified frozen cooked white rice.

Furthermore, the present invention can provide modified frozen cooked rice (hereinafter also to be referred to as “the so frozen cooked rice of the present invention” in the present specification).

The frozen cooked rice of the present invention contains the modifier of the present invention. As used herein, the “frozen cooked rice” and the “modifier of the present invention” are as mentioned above with respect to the modifier for frozen cooked rice of the present invention.

n the frozen. cooked rice of the present invention, “containing the modifier of the present invention” means that the modifier of the present invention exists in a state of covering the surface of rice grains of frozen cooked rice, or a state in which the modifier of the present invention is impregnated inside the rice grains of frozen cooked rice.

The frozen cooked rice of the present invention is improved in the separately freezing property and is easily loosened.

When the frozen cooked rice of the present invention contains the modifier of the above-mentioned preferred embodiment of the present invention, the texture and state of cooked rice obtained by thawing frozen cooked rice by a microwave cooker is improved in addition to the freezing property of frozen cooked rice so that the rice grains are frozen separately from each other, the stickiness during eating is absent, and good texture and good state with less viscosity can be achieved.

The frozen cooked rice of the present invention is particularly preferably provided as frozen cooked white rice.

Other features of the invention will become apparent in the course of the following descriptions of exemplary embodiments which are given for illustration of the invention and are not intended to be limiting thereof.

### EXAMPLES

Examples 1 to 7 and Comparative Examples 1 to 6

### Modifier for Frozen Cooked Rice

The emulsifiers (each 0.24 g) shown in Table 1 were added to an oil (high oleic canola oil, 8.7 and mixed to prepare the modifiers for frozen cooked rice of Examples 1 to 7 and Comparative Examples 1 to 6 (hereinafter to be abbreviated as “the modifier of Example 1”, and “the modifier of Comparative Example 1”).

The starting materials used for the preparation of the above-mentioned modifiers were as follows.
(1) high oleic canola oil: “J-Super canola oil” (J-Oil Mills, Inc.)
(2) qlyceryl monostearate: “EMULSY MM Super V” (Riken Vitamin Co., Ltd.)
(3) diglyceryl monostearate: “POEM J-2081V” (Riken Vitamin Co., Ltd.)
(4) sorbitan monostearate: “POEM S-60V” (Riken. Vitamin Co., Ltd.)
(5) glyceryl monooleate: “SUNSOFT No.8070V” (Taiyo Kagaku Co., Ltd.)
(6) glyceryl monolaurate: “SUNSOFT No.750” (Taiyo Kagaku. Co., Ltd.)
(7) decaglyceryl monostearate: “POEM J-0081HV” (Riken Vitamin Co., Ltd.)
(8) sucrose stearic acid ester: “S-370” (Mitsubishi Chemical Holdings Corporation)
(9) propylene glycol monooleic acid ester: “RIKEMAL PO-100V” (Riken Vitamin Co., Ltd.)
(10) glyceryl monocaprate: “SUNSOFT No.760” (Taiyo Kagaku Co., Ltd.)
(11) glyceryl monocaprylate: “POEM M-100” (Riken. Vitamin Co., Ltd.)
(12) soybean lecithin.: “J lecithin CL 18 kg can” (J-Oil Mills, Inc.)
(13) propylene glycol monostearic acid ester: “SUNSOFT No. 25CD” (Taiyo Kagaku Co., Ltd.)
(14) diglyceryl mono-dioleate: “SUNSOFT Q-17B” (Taiyo Kagaku Co., Ltd.)

### Experimental Example 1

### Evaluation of Separately Freezing Property of Frozen Cooked Rice

The modifiers (each 8.9 g) of the Examples and Comparative Examples were mixed with polished white rice (450.0 g) and water (562.0 g) (amount of modifier added to polished white rice=2.0 wt %, amount of each emulsifier added=0.053 wt %), and. cooked with a can rice cooker (“RR-050FS” (Rinnai Corporation)) using the heat for cooking 3 cups of rice. The rice (500 g) after rice cooking and snow-like dry ice (500 were placed in a bowl and stirred at 1st speed for 30 seconds using Kitchen Aid (FMI Corporation) to perform rapid freezing into separate rice grains. The rice after the rapid freezing was passed through a sieve (aperture 6.7 mm), and the weight of m the cooked rice remaining on the sieve, that is, the rice adhered to each other, was measured, and the ratio to the total amount of the frozen cooked rice was determined and used as an index of the separately freezing property.

The separately freezing property was evaluated as “◯” when the above-mentioned. index was not more than 35%, and “X” when it exceeded 35%, and shown in Table 1.

TABLE 1

| | | | |
|---|---|---|---|
| modifier | | | separately |
| for frozen | | HLB | freezing |
| cooked rice | emulsifier | value | property |

| | | | | |
|---|---|---|---|---|
| Example 1 | glyceryl monostearate | 4.3 | 25% | ◯ |
| Example 2 | diglyceryl monostearate | 6 | 15% | ◯ |
| Example 3 | sorbitan monostearate | 5.1 | 31% | ◯ |
| Example 4 | glyceryl monooleate | 4.1 | 26% | ◯ |
| Example 5 | glyceryl monolaurate | 5.3 | 35% | ◯ |
| Example 6 | propylene glycol | 3.9 | 21% | ◯ |
| | monostearic acid ester | | | |
| Example 7 | diglyceryl mono-dioleate | 6.5 | 34% | ◯ |
| Comparative | decaglyceryl | 12 | 63% | X |
| Example 1 | monostearate | | | |
| Comparative | sucrose stearic | about | 48% | X |
| Example 2 | acid ester | 3 | | |
| Comparative | propylene glycol | 3.6 | 67% | X |
| Example 3 | monooleic acid ester | | | |
| Comparative | glyceryl | 6.5 | 56% | X |
| Example 4 | monocaprate | | | |
| Comparative | glyceryl | 7 | 63% | X |
| Example 5 | monocaprylate | | | |
| Comparative | Soybean | 7-9 | 54% | X |
| Example 6 | lecithin | | | |

As shown in Table 1, when the modifiers of Examples 1, 4, and 5, each containing a monoester of saturated or unsaturated fatty acid having 12 to 18 carbon atoms and glycerol as the emulsifier, the modifier of Example 2 containing a monoester of stearic acid and diglycerol (average degree of polymerization=2) as the emulsifier, the modifier of Example 7 containing a monoester of oleic acid and diglycerol (average degree of polymerization=2) (mixture with diester) as the emulsifder, the modifier of Example 3 containing a monoester of stearic acid and sorbitan as the emulsifier, or the modifier of Example 6 containing a monoester of stearic acid and propyleneglycol as the emulsifier was used, frozen cooked rice produced by rapid freezing into separate rice grains showed good separately freezing property.

On the other hand, when the modifier of Comparative Example 1 containing a monostearic acid ester of decaglycerol (average degree of polymerization=10) as the emulsifier, the modifiers of Comparative Examples 2, 3, and 6 respectively containing sucrose stearic acid ester, monooleic acid ester of propylene glycol, and soybean lecithin as the emulsifier, and the modifiers of Comparative Examples 4 and 5 each containing a monoester of fatty acid having not more than 10 carbon atoms and glycerol as the emulsifier were used, frozen cooked rice produced by rapid freezing into separate rice grains did not show good separately freezing property.

The above-mentioned results of Experimental Example 1 suggest that an oil or fat composition containing, a monoester of fatty acid having 12 to 18 carbon atoms, and glycerol, polyglycerol with low average polymerization degree, or sorbitan, or a monoester of saturated fatty acid having 12 to 18 carbon atoms and pronyleneglycol, as an emulsifier is preferably used as a. modifier for frozen cooked rice.

In addition, it was shown that good separately freezing property can be afforded using an emulsifier with an HLB value of 3.9 to 6.5 as an emulsifier contained in the modifier of the present invention.

### Experimental Example 2

### Evaluation of Texture and State of Rice Thawed By Microwave Cooker

Frozen cooked rice produced by adding the modifiers of Examples 1 to 7 that showed good separately freezing property in the above-mentioned Experimental Example 1 were evaluated for the texture and state of rice after thawing by a microwave cooker.

The frozen cooked rice (100 g each) produced in Experimental Example 1 by adding each modifier of Examples 1 to 7 was placed. on a dish, wrapped, and thawed by heating in a microwave cooker (Kitchen microwave “NE-TY152” (Panasonic Corporation)) at 500 W for 1 minute and 30 seconds. Then, sensory evaluation of the stickiness and viscosity during eating the rice after thawing was performed. according to the following evaluation criteria by three professional panelists. The evaluation results were determined on mutual agreement by the panelists. The evaluation results are shown in Table 2.

### Evaluation Criteria

TABLE 2

| modifier | | | |
|---|---|---|---|
| for frozen | | | |
| cooked rice | emulsifier | stickiness | viscosity |
| Example 1 | glyceryl monostearate | − | + |
| Example 2 | diglyceryl monostearate | − | + |
| Example 3 | sorbitan monostearate | − | + |
| Example 4 | glyceryl monooleate | ++ | +++ |
| Example 5 | glyceryl monolaurate | ++ | +++ |
| Example 6 | propylene glycol | − | + |
| | monostearic acid ester | | |
| Example 7 | diglyceryl mono-dioleate | + | ++ |

(1) stickiness when eating rice
not sticky or little sticky; −
slightly sticky; +
sticky; ++
(2) viscosity of rice
low viscosity; +
slightly high viscosity; ++
high viscosity; +++

As shown in Table 2, the frozen cooked rice produced using the modifiers of Examples 1 to 3 and 6, each containlng a monoester of stearic acid and glycerol, diglycerol, sorbitan, or propyleneglycol as an emulsifier showed good texture and good state of rice after thawing using a microwave cooker. In addition, the frozen cooked rice produced using the modifiers of Example 7 containing a monoester of oleic acid and diglycerol (average degree of polymerization=2) (mixture with diester) as the emulsifier was evaluated to show slight stickiness and viscosity in the rice after thawing using a microwave cooker, but, mostly good texture and good state.

That is, the frozen cooked rice produced using each modifier of Examples 1 to 3, 6, and 7 was superior in the texture and state of rice after thawing using a microwave cooker, as compared with the frozen cooked rice produced using the modifier of Example 4 containing a monoester of oleic acid, which is an unsaturated fatty acid, and glycerol as the emulsifier, and the modifier of Example 5 containing a monoester of lauric acid having 12 carbon atoms and glycerol as the emulsifier,

The above-mentioned results of Experimental Example 2 suggest that, from the aspects of the texture and state of rice after thawing using a microwave cooker, an oil or fat composition containing, as an emulsifier, a monoester of saturated. fatty acid having not less than 14 carbon atoms, and glycerol, sorbitan, or propyleneglycol, or a monoester of fatty acid having not less than 14 carbon atoms and poLyglycerol with low average degree of polymerization, is more preferable as a modifier for frozen cooked rice.

### Experimental Example 3

### Consideration of Effect of Emulsifier Content on Modifier for Frozen Cooked Rice

In the same manner as in Experimental Example 1, frozen cooked rice was produced using a modifier prepared by setting the amount of the emulsifier (glyceryl monostearate) in the modifier of Example 1 to 1/3-fold, 2-fold, 16-fold, or 12.8-fold amount with respect to the oil (8.7 g) (Examples 8 to 11).

In the same manner as in Experimental Example 1, frozen cooked rice was produced using a modifier prepared by setting the amount of the emulsifier (glyceryl monostearate) in the modifier of Example 1 to 1/12-fold or 1/6-fold amount with respect to the oil (8.7 g) (Reference Examples 1 and 2).

In the same manner as in Experimental Example 1, frozen cooked rice was produced using the modifier of Example 1, and used as a control.

In the production of frozen cooked rice, the amount of an emulsifier (glyceryl monostearate), the amount of a modifier S for frozen cooked rice, the content of an emulsifier (glyceryl monostearate) in a modifier for frozen cooked rice added, and the amount of an emulsifier (glyceryl monostearate) with respect to polished rice are shown in Table 3.

Each of the produced frozen cooked rice was evaluated for the separately freezing property of frozen cooked rice in the same manner as in the above-mentioned Experimental Example 1. In addition, evaluation similar to that in Experimental Example 2 was performed except that the texture and state of rice after thawing each produced frozen cooked rice by a microwave cooker were evaluated according to the following evaluation criteria. The evaluation results are also shown in Table 3.

### Sensory Evaluation Criteria of Texture and State of Rice After Thawing

TABLE 3

| | | | content | | | | | |
|---|---|---|---|---|---|---|---|---|
| | | amount of | (wt %) of | amount of | | | | |
| | | modifier | emulsifier | emulsifier | | | | |
| | amount of | for frozen | in modifier | (wt %) based | separately | | | |
| | emulsifier | cooked rice | for frozen | on polished | freezing | | | |
| production method | (g) | (g) | cooked rice | white rice | property | | stickiness | viscosity |
| control | 0.24 | 8.94 | 2.68 | 0.053 | 25% | ◯ | − | + |
| Example 8 | 0.08 | 8.78 | 0.91 | 0.018 | 32% | ◯ | + | ++ |
| Example 9 | 0.48 | 9.18 | 5.23 | 0.11 | 11% | ◯ | −− | − |
| Example 10 | 3.84 | 12.54 | 30.7 | 0.85 | 5% | ◯ | −− | − |
| Example 11 | 30.72 | 39.42 | 77.9 | 6.83 | 4% | ◯ | −− | − |
| Reference Example 1 | 0.02 | 8.72 | 0.23 | 0.0044 | 47% | X | ++ | +++ |
| Reference Example 2 | 0.04 | 8.74 | 0.46 | 0.0088 | 54% | X | ++ | +++ |

(1) stickiness when eating rice
not sticky; −−
little sticky; −
slightly sticky; +
sticky; ++
(2) viscosity of rice
very low viscosity; −
low viscosity; +
slightly high viscosity; ++
high viscosity; +++

As shown in Table 3, when frozen cooked rice was produced using a modifier obtained by setting the amount of the emulsifier to 1/3 of the emulsifier in the modifier of Example 1 with respect to the oil (Example 8), and when frozen cooked rice was produced using a modifier obtained by setting the amount of the emulsifier in the modifier of Example 1 to 2-fold, 16-fold, or 128-fold with respect to the oil (Examples 9 to 11), frozen cooked rice with good separately freezing property was obtained as in the case of producing frozen cooked rice using the modifier of Example 1 (control).

In addition, when thawed using a microwave cooker, the frozen cooked rice produced in Example 8 showed slight stickiness and viscosity after thawing; however, the frozen cooked rice produced in Examples 9 to 11 did not show stickiness after thawing but showed good texture and state with very low viscosity.

When frozen cooked rice was produced using a modifier obtained by setting the amount of the emulsifier to 1/12-fold or 1/6-fold that of the emulsifier in the modifier of Example 1 with respect to the oil (Reference Examples 1 and 2), sufficient separately freezing property was not found. When thawed using a microwave cooker, the texture and state of the rice showed. stickiness, and the viscosity was evaluated to be high.

The above-mentioned results of Experimental Example 3 reveal that the content of an emulsifier in a modifier for frozen cooked rice is more preferably 0.9 wt % to 78 wt %, and that, in the production of frozen cooked rice, the modifier is preferably added such that the amount of the emulsifier would be 0.018 wt % to 6.8 wt % with respect to the polished white rice.

### Experimental Example 4

### Consideration of Effect of the Kind of Oil or Fat on Modifier for Frozen Cooked Rice

The high oleic canola oil in the above-mentioned modifier of Example 1 was replaced with the oil or fat shown in Table 4, and used as the modifiers of Examples 12 to 14.

In Table 4, the products commercially available for foods were used as canola oil, palm oil, and lard.

TABLE 4

| Example | oil or fat |
|---|---|
| 12 | canola oil |
| 13 | palm oil |
| 14 | lard |

In the same manner as in Experimental Example 1, frozen cooked rice was produced using the modifiers of Examples 12 to 14, and separately freezing property was evaluated. In addition, the texture and state of rice after thawing by a microwave cooker were evaluated in the same manner as in Experimental Example 2.

As a result, the frozen cooked rice produced using the modifiers of Examples 12 to 14 showed good separately freezing property, and when thawed using a microwave cooker, the rice after thawing showed good texture and good state.

The above-mentioned results of Experimental Example 4 suggest that the kind of oil or fat has a small effect on the modifier of the present invention.

### Experimental Example 5

### Consideration of Effect of Thawing Method on Texture and State of Thawed Rice

Frozen cooked rice produced. by adding the modifier of Example 1 that showed good. separately freezing property in the above-mentioned Experimental Example 1 was thawed by steam cooking (frozen cooked rice (450 g) was placed in a pouch, a pinhole was made in the pouch, and the rice was heated in a steam cooker for 25 min) and frying pan cooking (frozen cooked rice (450 g) was heated in a frying pan (diameter 26 cm) for 5 min to 6 min with medium fire of a stove burner), and the texture and state of rice after thawing were evaluated.

As a result, the texture and. state of rice after thawing by steam cooking and. frying pan cooking were fine.

The above-mentioned results of Experimental Example 5 suggest that frozen cooked rice produced by adding the modifier of the present invention affords rice with good texture and good state even when thawed by a thawing method other than use of a microwave cooker.

### INDUSTRIAL APPLICABILITY

As described in detail above, according to the present invention, a. modifier for frozen cooked rice is provided. that can favorably improve the freezing property of cooked rice during rapid freezing so that the rice grains are frozen separately from each other.

According to the present invention, a method for modifying frozen cooked rice is provided that can improve the freezing property of cooked rice during rapid freezing so that the rice grains are frozen separately from each other.

Accordingto the present invention, moreover, a method for producing frozen cooked rice is provided, which frozen cooked rice is improved in the freezing property of cooked rice during rapid freezing so that the rice grains are frozen separately from each other and become loose with ease.

According to the present invention, furthermore, frozen cooked rice is provided that is improved in the freezing property of cooked rice during rapid freezing so that the rice grains are frozen separately from each other, and modified to become loose with ease after freezing.

In a preferred embodiment, of the present invention, a so modifier for frozen cooked rice is provided that can improve, in addition to the freezing property of cooked rice during rapid freezing so that the rice grains are frozen separately from each other, the texture and state of cooked rice obtained by thawing frozen cooked rice by a microwave cooker.

In a preferred embodiment of the present invention, a method for modifying frozen cooked rice is provided that can improve, in addition to the freezing property of cooked rice during rapid freezing so that the rice grains are frozen separately from each other, the texture and state of cooked rice obtained by thawing frozen cooked rice by a microwave cooker.

In a preferred embodiment of the present invention, moreover, a method for producing frozen cooked rice is provided, which frozen cooked rice is improved in, in addition to the freezing property of cooked rice during rapid freezing so that the rice grains are frozen separately from each other, the texture and state of cooked rice obtained by thawing frozen cooked rice by a microwave cooker.

In a preferred embodiment of the present invention, furthermore, frozen cooked rice is provided that shows, in addition to the freezing property of cooked rice during rapid freezing so that the rice grains are frozen separately from each other, good texture and good state of cooked rice after thawing by a microwave cooker, and is suitable for thawing by a microwave cooker.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A modifier for frozen cooked rice, comprising at least one emulsifier and at least one oil or fat, wherein said at least one emulsifier comprises one or more members selected from the group consisting of a monoester of a fatty acid having 12 to 22 carbon atoms and glycerol, a monoester of a fatty acid having 12 to 22 carbon atoms and sorbitan, a monoester of a fatty acid having 12 to 22 carbon atoms and a olyglycerol with an average degree of polymerization of 2 to 5, and a monoester of a saturated fatty acid having 12 to 22 carbon atoms and propylene glycol.

2. The modifier according to claim 1, wherein said at least one emulsifier comprises one or more members selected from the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of a fatty acid having 14 to 22 carbon atoms and a polyglycerol with an average degree of polymerization of 2 to 5.

3. The modifier according to claim 1, wherein said at least one emulsifier has an FMB (Hydrophilic-Lipophilic Balance) value of 3.8 to 6.5.

4. The modifier according to claim 1, wherein a content of said at least one emulsifier is 0.6 wt % to 80 wt % based on the total amount of the modifier.

5. A method for modifying frozen cooked rice, comprising bringing uncooked ri ce grains used for producing frozen cooked rice into contact with a modifier for frozen cooked rice which comprises at least one emulsifier and at least one oil or fat, wherein said at least one emulsifier comprises one or more members selected from the group consisting of a monoester of a fatty acid having 12 to 22 carbon. atoms and glycerol, a monoester of a fatty acid. having 12 to 22 carbon atoms and sorbitan, a monoester of a fatty acid having 12 to 22 carbon atoms and a polyglycerol with an average degree of polymerization of 2 to 5, and a monoester of a saturated fatty acid having 12 to 22 carbon atoms and propylene glycol.

6. The method according to claim 5, wherein said at least one emulsifier comprises one or more members selected from the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of a fatty acid having 14 to 22 carbon atoms and a polyglycerol with an average degree of polymerization of 2 to 5.

7. The method according to claim 5, wherein said at least one emulsifier has an. HIB (Hydrophilic-Lipophilic Balance) value of 3.8 to 6.5.

8. The method according to claim 5, wherein a content of said at least one emulsifier is 0.6 wt % to 80 wt % based on the total amount of the modlfier.

9. The method according t.o claim 5, wherein an amount of said at least one emulsifier is 0.01 g to 7 g per 100 g of the rice.

10. The method according to claim 6, wherein the frozen cooked rice is to be thawed by a microwave cooker.

11. The method according to claim 5, wherein the frozen cooked rice is frozen cooked white rice.

12. A method for producing frozen cooked rice, comprising a step of adding water, at least one emulsifier, and at least one oil or fat to uncooked rice and cooking the rice, or adding water to uncooked rice, cooking the rice, and adding at least one emulsifier and. at least one oil or fat to the cooked rice, and a step of rapidly freezing the cooked rice to give rice grains frozen separately from each other, wherein said at least one emulsifier comprises one or more members selected from the group consisting of a monoester of a fatty acid having 12 to 22 carbon atoms and glycerol, a monoester of a fatty acid having 12 to 22 carbon atoms and sorbitan, a monoester of a fatty acid. having 12 to 22 carbon atoms and a polyglycerol with an average degree of polymerization of 2 to 5, and a monoester of a saturated fatty acid having 12 to 22 carbon atoms and propylene glycol.

13. The method according to claim 12, wherein said at least one emulsifier comprises one or more members selected from the group consisting of a monoester of a saturated fatty acid having 14 to 22 carbon atoms and glycerol, a monoester of a saturated fatty acid having 14 to 22 carbon atoms and sorbitan, a monoester of a saturated fatty acid having 14 to 22 carbon atoms and propylene glycol, and a monoester of a fatty acid having 14 to 22 carbon atoms and a polyglycerol with an average degree of polymerization of 2 to 5.

14. The method according to claim 12, wherein said at least one emulsifier has an HLB (Hydrophilic-Lipophilic Balance) value of 3.8 to 6.5.

15. The method according to claim 12, wherein a content of said at least one emulsifier is 0.6 wt % to 80 wt % based on the total amount of the oil or fat and the emulsifier.

16. The method according to claim 12, wherein an amount of said at least one emulsifier is 0.01 g to 7 g per 100 g of the rice.

17. The method according to claim 13 wherein the frozen cooked rice is to be thawed by a microwave cooker.

18. The method according to claim 12, wherein the frozen cooked rice is frozen cooked white rice.

19. A modified frozen cooked rice comprising the modifier according to claim 1.

20. A modified frozen cooked rice comprising the modifier according to claim 2 and to he thawed by a microwave cooker.

21. The frozen cooked rice according to claim 19, wherein the frozen cooked rice is frozen cooked white rice.
